(19) United States
(12) Patent Application Publication
(10) Pub. No.: US 2006/0171078 A1
(43) Pub. Date: Aug. 3, 2006

(54) Information storage apparatus

(75) Inventor: Osamu Kajitani, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/102,714

(22) Filed: Apr. 11, 2005

(30) Foreign Application Priority Data
Jan. 31, 2005 (JP) 2005-23485

(51) Int. Cl. G11B 5/54

(52) U.S. Cl. 360/254.7

(57) ABSTRACT

An information storage apparatus comprises: a slider having a head that performs information access to an information recording medium for storing information; an arm that holds the slider so that the head is closed to or in contact to a surface of the information storage medium; a tub fixed on the arm, wherein at least a part of the tub is over against the surface of the information recording medium; an actuator that causes the slider held by the arm to travel along the surface of the information recording medium when the arm is rotatably moved, wherein a travelling range of the slider extends to a saving position out of the information recording medium; and a ramp member that is in contact with a portion of the tub opposing the surface of the information recording medium, when the slider travels to the saving position through a rotatable movement of the arm by the actuator, so that the slider travels in a direction going away from the surface of the information recording medium, wherein a material of the ramp member is same as the tub.

### BACKGROUND OF THE INVENTION

1. Field of the Invention

The present invention relates to an information storage apparatus using an information storage medium for storing information.

2. Description of the Related Art

As an example of an information storage apparatus for storing information on an information storage medium, hitherto, there is known a magnetic disk unit. The magnetic disk unit has a magnetic disk as an information storage medium to perform recording and reproducing of information in such a manner that a magnetic head comes close to a surface of the magnetic disk while the magnetic disk rotates at high speed.

According to the magnetic disk unit, a magnetic head is mounted on a slider that slides on the surface of the magnetic disk on a floating basis. However, if the slider exists on the magnetic disk when the magnetic disk stops in rotation while the magnetic disk unit is in the stop state or in the inactive state, there is a possibility of occurrence of a head crash obstacle in which the slider or the magnetic head collides with the magnetic disk and as a result the magnetic disk and the magnetic head are damaged, when the magnetic disk unit is activated to restart the rotation of the magnetic disk. For the reasons described above, there is proposed a load and unload mechanism in which while the magnetic disk stops in rotation the slider is unloaded to a saving position outside the magnetic disk, and when the magnetic disk restarts in rotation the slider is loaded on the magnetic disk.

According to the load and unload mechanism as mentioned above, there is provided such a mechanism that when the slider is placed at the saving position, the slider is located at a position that is away from the surface of the magnetic disk. This mechanism makes it possible to prevent the situation that the slider accidentally collides with the magnetic disk due to the vibration applied to the magnetic disk unit. As a system for causing the slider to locate at a position that is away from the surface of the magnetic disk, there is known a ramp road system using a ramp road having a tilt with respect to the surface of the magnetic disk. And there is developed a ramp road type of magnetic disk unit adopting the ramp road system (cf. for example, Japanese Patent Application Laid Open Gazette TokuKai Hei. 7-210845, page 8, FIG. 1, and Japanese Patent Application Laid Open Gazette TokuKai Hei. 14-367313, page 10, FIG. 11).

FIG. 9 is a schematic plan view of the conventional ramp road type of magnetic disk unit. According to a ramp road type of magnetic disk unit 91, a magnetic disk 93 is mounted on a spindle motor 94 that is fixed on a base plate 92 for supporting structural components. The spindle motor 94 drives the magnetic disk 93 at a predetermined rotary speed. A slider 95, which is loaded with a magnetic head for reading and writing magnetic information recorded on the magnetic disk 93, is mounted on a suspension 96.

A carriage 97 holds the suspension 96. An arm 98, which consists of an assembly of the suspension 96 and the carriage 97, is rotatably moved by an arm actuator 99 in a direction of unload of the head or in a direction of load of the head. A stainless tab 100 is mounted on the tip of the suspension 96. When the slider 95 is unloaded, the tab 100 slides together with a ramp member 101 made of resin, so that the slider 95 held by the arm 98 is away from the surface of the magnetic disk 93.

According to the conventional ramp road type of magnetic disk unit as mentioned above, when the ramp load is worn down by the sliding between the ramp load and the tab, this will bring about a vibration of the arm when the slider is loaded from the saving position on the magnetic disk. This causes the head crash and brings about a disturbance in a floating posture owing to adhesion of frictional wear powder on the magnetic head and/or the slider and thereby bringing about impossibility of recording and reproduction and damage of the magnetic disk. Hence, it is a subject that a stable operation of a magnetic disk unit is held for a long time through suppressing such a frictional wear and there is implemented a magnetic disk unit that is high in reliability and in useful life.

It is noted that the subject as mentioned above is not inherent to the magnetic disk unit and is common to such a type of information storage apparatus in which a head is closed to or in contact to an information storage medium using a slider.

### SUMMARY OF THE INVENTION

In view of the foregoing, it is an object of the present invention to provide an information storage apparatus that is high in reliability and-in useful life.

To achieve the above-mentioned object, the present invention provides an information storage apparatus comprising:

a slider having a head that performs information access to an information recording medium for storing information;

an arm that holds the slider so that the head is closed to or in contact to a surface of the information storage medium;

a tub fixed on the arm, wherein at least a part of the tub is over against the surface of the information recording medium;

an actuator that causes the slider held by the arm to travel along the surface of the information recording medium when the arm is rotatably moved, wherein a travelling range of the slider extends to a saving position out of the information recording medium; and

a ramp member that is in contact with a portion of the tub opposing the surface of the information recording medium, when the slider travels to the saving position through a rotatable movement of the arm by the actuator, so that the slider travels in a direction going away from the surface of the information recording medium, wherein a material of the ramp member is same as the tub.

According to the present invention, a material of the ramp member is the same as the tub. This feature makes it possible to implement the suppression of an occurrence of wear. As a result, a contact of the ramp member with the tub is smoothly implemented for a long time, and thus it is possible to avoid for a long time a possibility of occurrence of a head crash obstacle in unload and load of the slider. Further, according to the present invention, it is possible to suppress generation of wear powder. And thus it is possible to avoid for a long time occurrences of impossibility obstacle of recording and reproduction due to generation of wear powder. Accordingly, the information storage apparatus according to the present invention is high in useful life and reliability.

In the information storage apparatus according to the present invention as mentioned above, it is preferable that the arm has a projection extending in a direction along the surface of the information recording medium, and the tub covers the projection.

According to the information storage apparatus of the present invention as mentioned above, the tub is fixed on the arm readily and with greater accuracy. This feature makes it possible to simplify the production procedure and thereby implementing production of the tabs through the mass production.

In the information storage apparatus according to the present invention as mentioned above, it is preferable that the arm has a hole at a portion opposing the surface of the information recording medium, and the tub is engaged with the hole of the arm.

It is acceptable that the “hole” is a through-hole penetrating the arm, or a hole having the bottom, which does not penetrate the arm.

According to the information storage apparatus of the present invention as mentioned above, the tub is fixed on the arm readily and with greater accuracy in accordance with a way that the tub is engaged with the hole of the arm. This feature makes it possible to simplify the production procedure and thereby implementing production of the tabs through the mass production.

### BRIEF DESCRIPTION OF THE DRAWINGS

FIG. 1 is a schematic plan view of a ramp road type of magnetic disk unit according to a first embodiment of an information storage apparatus of the present invention.

FIG. 2 is a schematic perspective view showing an enlargement of a periphery portion of an arm of the ramp road type of magnetic disk unit according to a first embodiment of an information storage apparatus of the present invention.

FIG. 3 is a top view of a suspension as a comparison example.

FIG. 4 is a side view of a suspension as a comparison example.

FIG. 5 is a top view of the suspension in the first embodiment of the information storage apparatus of the present invention.

FIG. 6 is a side view of the suspension in the first embodiment of the information storage apparatus of the present invention.

FIG. 7 is a top view of the suspension in the second embodiment of the information storage apparatus of the present invention.

FIG. 8 is a side view of the suspension in the second embodiment of the information storage apparatus of the present invention.

FIG. 9 is a schematic plan view of the conventional ramp road type of magnetic disk unit.

### DETAILED DESCRIPTION OF PREFERRED EMBODIMENTS

Embodiments of the present invention will be described with reference to the accompanying drawings.

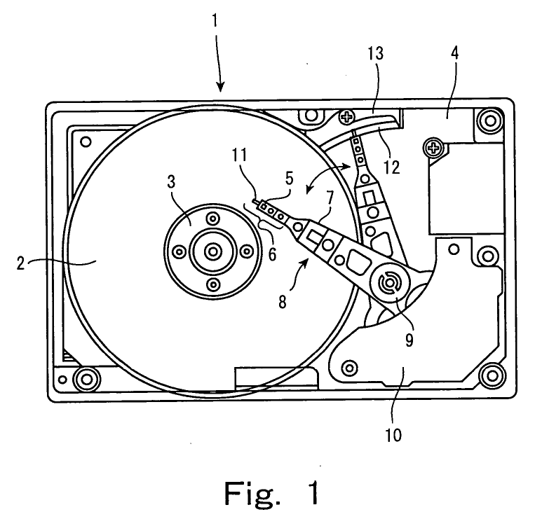

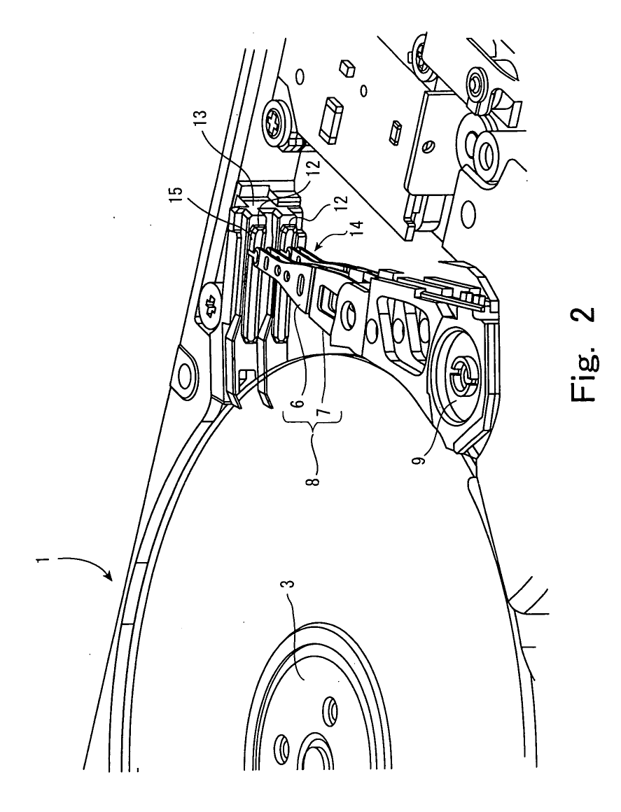

FIG. 1 is a schematic plan view of a ramp road type of magnetic disk unit according to a first embodiment of an information storage apparatus of the present invention. FIG. 2 is a schematic perspective view showing an enlargement of a periphery portion of an arm of the ramp road type of magnetic disk unit according to a first embodiment of an information storage apparatus of the present invention.

A magnetic disk unit 1 shown in FIG. 1 is used through connection with a large-scale computer and a personal computer or through incorporation therein.

According to the magnetic disk unit 1, a spindle motor 3 for rotatively driving a magnetic disk 2, which is a sort of an information recording medium, is mounted on a base plate 4 for supporting structural components of the magnetic disk unit 1.

The magnetic disk 2 is mounted on a rotary shaft of the spindle motor 3 so as to rotate at a predetermined rotary speed. Generally, the magnetic disk unit is provided with a single magnetic disk or a plurality of magnetic disks in accordance with uses. However, here, there will be explained the magnetic disk unit 1 of the present embodiment assuming that two pieces of magnetic disk 2 are mounted on the rotary shaft of the spindle motor 3. FIG. 1 shows a first magnetic disk 2 that is mounted on the rotary shaft of the spindle motor 3. A second magnetic disk (not illustrated) is mounted below the first magnetic disk 2 with leaving a space.

A slider 5, with is loaded with a magnetic head for performing information recording and reproduction to the magnetic disks 2, is supported by a suspension 6 and comes close to a surface of the magnetic disk. The suspension 6 is mounted on a carriage 7. An arm 8 consists of an assembly of the suspension 6 and the carriage 7. The arm 8 is provided on each of the front and back surfaces of two magnetic disks 2. That is, there are provided four pieces of arms 8 in association with four recording and reproduction surfaces of the front and back surfaces of two magnetic disks 2. A stack assembly 14, which consists of a coupled member of four pieces of arms 8, is mounted on an arm shaft 9 and is rotatably moved by an actuator 10.

When the actuator 10 rotatably moves the stack assembly 14, the slider 5 moves along the surface of the magnetic disk 2. A moving range of the slider 5 by the actuator 10 extends to the saving position out of the magnetic disk 2. On the top of the arm 8, there is provided a tab 11. When the actuator 10 moves the slider 5 to the saving position, the tab 11 slides on a ramp member 12, so that the slider 5 is separated from the surface of the magnetic disk 2.

The ramp member 12 is installed on a supporting member 13 and is mounted on the base plate 4. According to the present embodiment, two ramp members 12 are provided on two magnetic disks 2, respectively. Each of the ramp members 12 has two ramp roads 15 at the upper and lower sides so that the two tabs 11 can run.

Each ramp road little inclines with respect to the surface of the magnetic disk 2, and as a result, when the tab 11 runs toward the saving position, the slider 5 is away from the surface of the magnetic disk 2.

Here, there will be explained a comparison example of the suspension 6 used in the present embodiment with the conventional suspension.

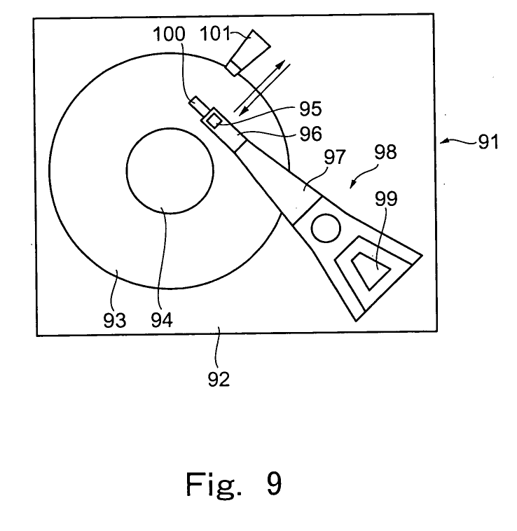

FIG. 3 is a top view of a suspension as a comparison example. FIG. 4 is a side view of a suspension as a comparison example. On the top of a suspension 31, there is provided a stainless tab 32 processed in a united body with the suspension 31 made of stainless material in a similar fashion to that of the conventional ramp road type of magnetic disk unit shown in FIG. 9.

There will be explained hereinafter a problem involved in a case where the suspension 31 is used with replacement of the suspension 6 of the magnetic disk unit according to the first embodiment.

When the tab 32, which is provided on the suspension 31 as the comparison example, runs on the ramp member 12, friction between the tab 32 and the ramp member 12 is equivalent to friction between stainless and resin, and thus such a friction becomes abrasive wear due to friction between mutually different kind of materials as physical characteristics of wear, and thereby bringing about great wear. Accordingly, there is a possibility of occurrence of a head crash obstacle owing to deterioration in a sliding ability between the ramp member 12 and the tab 32 and occurrences of impossibility obstacle of recording and reproduction due to generation of wear powder and damage of magnetic disk. Hence, the magnetic disk unit using the suspension 31 as the comparison example is low in useful life and reliability.

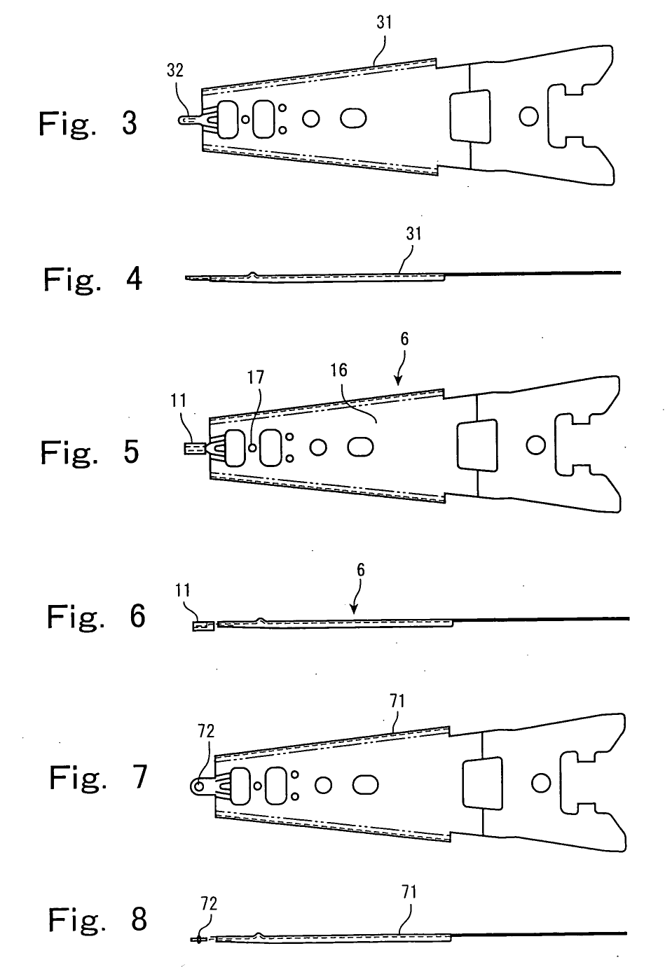

FIG. 5 is a top view of the suspension 6 in the first embodiment of the information storage apparatus of the present invention. FIG. 6 is a side view of the suspension 6 in the first embodiment of the information storage apparatus of the present invention. The suspension 6 comprises a load beam 16 having flexibility to balance buoyancy of the slider, and a gimbal 17 on which the slider is mounted. On the top of the suspension 6, there is provided a projection extending in a direction along the surface of the magnetic disk. A cylindrical tab 11 made of resin is fixed on the projection in a state that the cylindrical tab 11 covers the projection. It is possible to produce the tab 11 with greater accuracy in accordance with a simple way and thereby inexpensively implementing production of the tabs through the mass production. As the resin here to be used, anyone is preferable, which is excellent in sliding ability, abrasive resistance and moldability, and for example, liquid crystal polymer and the like may be used. When the tab 11 runs on a travelling path 15 of the ramp member 12, friction between the tab 11 and the ramp member 12 offers friction between resins, and thus as physical characteristics of wear, there is offered a so-called agglutination wear. The agglutination wear is greatly less in amount of wear as compared with abrasive wear generated owing to friction between mutually different kind of materials. Accordingly, the wear of the ramp member 12 according to the present embodiment is greatly reduced, so that a travelling of the tab 11 on the travelling path 15 is stabilized for a long time, and thereby suppressing generation of the wear powder. As a result, the magnetic disk unit 1 of the present embodiment is high in reliability and in useful life.

Next, there will be explained a second embodiment of the present invention. The second embodiment is substantially the same as the first embodiment excepting the suspension and the tub. Thus, hereinafter, there will be explained only the different points and redundant explanation will be omitted.

FIG. 7 is a top view of a suspension in the second embodiment of the information storage apparatus of the present invention. FIG. 8 is a side view of a suspension in the second embodiment of the information storage apparatus of the present invention. Hereinafter, there will be explained the suspension in their combination of FIG. 7 and FIG. 8. On the top of a suspension 71, there is provided a through-hole penetrating the front and the back. A tub 72 made of resin is fixed on the through-hole in a state that the tub 72 is engaged with the through-hole. It is possible to produce the tab 72 too with greater accuracy in accordance with a simple way and thereby inexpensively implementing production of the tabs through the mass production.

Also in the second embodiment, when the tab 72 runs on the ramp member 12, friction between the tab 72 and the ramp member 12 offers friction between resins, and thus as physical characteristics of wear, there is offered a so-called agglutination wear. The agglutination wear is greatly less in amount of wear as compared with abrasive wear generated owing to friction between mutually different kind of materials. Accordingly, the wear of the ramp member 12 according to the second embodiment is also greatly reduced. As a result, the magnetic disk unit of the second embodiment is also high in reliability and in useful life.

Incidentally, according to the above-mentioned explanation, as an example of the arm referred to in the present invention, there is shown an arm consisting of an assembly of the suspension and the carriage. However, it is acceptable that the arm referred to in the present invention is formed in a united body.

Further, according to the above-mentioned explanation, as an example of the tub referred to in the present invention, there is shown the tub provided in such a manner that a part of the tub exists on both the sides of the arm. However, it is acceptable that the tub referred to in the present invention is provided on only the side of the arm, which is over against the information recording medium. Furthermore, according to the above-mentioned explanation, there is shown an example in which the tub is provided on the top of the arm. However, it is acceptable that the tub referred to in the present invention is provided in half way of the arm.

Still further, according to the above-mentioned explanation, there is shown an example in which an information storage apparatus of the present invention is applied to a magnetic disk unit. However, it is acceptable that the information storage apparatus of the present invention is applied to an optical information storage apparatus in which lens and the like are mounted on a slider to perform information access through light.

As mentioned above, according to the information storage apparatus of the present invention, it is possible to provide an information storage apparatus that is high in reliability and in useful life.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An information storage apparatus comprising:
a slider having a head that performs information access to an information recording medium for storing information;
an arm that holds the slider so that the head is closed to or in contact to a surface of the information storage medium;
a tub fixed on the arm, wherein at least a part of the tub is over against the surface of the information recording medium;
an actuator that causes the slider held by the arm to travel along the surface of the information recording medium when the arm is rotatably moved, wherein a travelling range of the slider extends to a saving position out of the information recording medium; and
a ramp member that is in contact with a portion of the tub opposing the surface of the information recording medium, when the slider travels to the saving position through a rotatable movement of the arm by the actuator, so that the slider travels in a direction going away from the surface of the information recording medium, wherein a material of the ramp member is same as the tub.

2. An information storage apparatus according to claim 1, wherein the arm has a projection extending in a direction along the surface of the information recording medium, and
the tub covers the projection.

3. An information storage apparatus according to claim 1, wherein the arm has a hole at a portion opposing the surface of the information recording medium, and
the tub is engaged with the hole of the arm.
